(19) United States
(12) Patent Application Publication
(10) Pub. No.: US 2003/0094112 A1
(43) Pub. Date: May 22, 2003

(54) Printing 3-dimensional substrates

(76) Inventors: Alfred Robert Coningsby, Ft. Lauderdale, FL (US); Todd Darren Coningsby, Ft. Lauderdale, FL (US); Christopher Frank Dunn, Cardiff (GB)

Correspondence Address: VEDDER PRICE KAUFMAN & KAMMHOLZ, 222 N. LASALLE STREET, CHICAGO, IL, 60601, US

(21) Appl. No.: 10/324,726

(22) Filed: Dec. 19, 2002

Related U.S. Application Data
(63) Continuation of application No. 09/707,705, filed on Nov. 6, 2000, now abandoned.

(51) Int. Cl. B41C 1/00

(52) U.S. Cl. 101/483

(57) ABSTRACT

A method of printing successive serial numbers onto optical storage disks 12 comprises applying a printing substance to a print head 19 carrying reverse impressions of a series of serial numbers, applying the print head 19 to the surface of a disk 12 to be printed to print a serial number thereon, removing the print head 19 from the disk 12 and incrementing its presented serial number prior to contacting the print head 19 with the surface of a subsequent substrate to be printed.

The surface of optical storage disks 12 can thus be printed with serial numbers using a permanent ink in register with other printing on the surface of the disk.

### BACKGROUND OF THE INVENTION

This invention relates to the printing of incremental data onto successive 3-dimensional substrates such as optical data storage disks or so-called CDs.

CDs are generally printed on one side with a label which, for example, identifies the nature of the data contained thereon. A disadvantage of CDs is that they are relatively easy to forge and as such it has been desired to provide some way of providing each disk with a unique serial number.

It is well known to print serial numbers onto the hub of the CD during the manufacturing process using an ink-jet printer. Such serial numbers are easy to remove and are not in register with the label which is subsequently printed.

Accordingly, we have now devised a method of printing incremental data onto successive 3-dimensional substrates, such as CDs, which alleviates the above-mentioned problems.

### SUMMARY OF THE INVENTION

In accordance with this invention, there is provided a method of printing incremental data onto successive 3-dimensional substrates comprising applying a printing substance to a print head carrying reverse impressions of a series of characters, applying the print head to the surface of the substrate to be printed to print a character, removing the print head from the substrate and changing character prior to contacting the print head with the surface of a subsequent substrate to be printed.

In this manner, the surface of a substrate such as a CD can be printed with characters such as serial numbers using a permanent ink in register with other printing.

Preferably, the printing substance is applied to a transfer element, the print head being contacted with the transfer element to apply the substance thereto.

Preferably the substrate is printed with an image prior to, subsequent to, or simultaneously with applying said print head to the substrate.

Also in accordance with this invention, there is provided an apparatus for printing incremental data onto successive 3-dimensional substrates comprising a print head carrying reverse impressions of a series of characters, means for applying a printing substance to the print head, means for applying the print head onto the surface of the substrate to be printed to print a character thereon, and means for changing the character prior to printing onto a subsequent substrate.

Preferably, the print head is rotatably mounted for rotation between a first position in which it contacts said means for applying the printing substance and a second position in which it contacts said substrate.

Preferably said means for changing the character changes the character during rotational movement of the head.

Preferably, the print head comprises an actuator which contacts a projection on the apparatus during rotational movement of the head to change the character.

Preferably the head rotates about an axis which extends parallel to the region of surface of the substrate on which the serial number is to be printed.

Preferably said means for applying the printing substance comprises a roller arranged for rotation about an axis which extends parallel to the axis of rotation of the head, means being provided for applying said substance to the roller.

Preferably, the head and roller rotate in opposite directions.

Preferably, said substrate is mounted on a conveyor arranged to advance the substrate through successive printing stations, one of which comprises said print head.

These and other objects, features and advantages of the present invention will become apparent from the following detailed description, taken in conjunction with the accompanying drawings, wherein like reference numerals refer to like parts.

### BRIEF DESCRIPTION OF THE DRAWINGS

An embodiment of this invention will now be described by way of example only and with reference to the accompanying drawings in which:

FIG. 1 is a side view of a printing apparatus in accordance with this invention; and

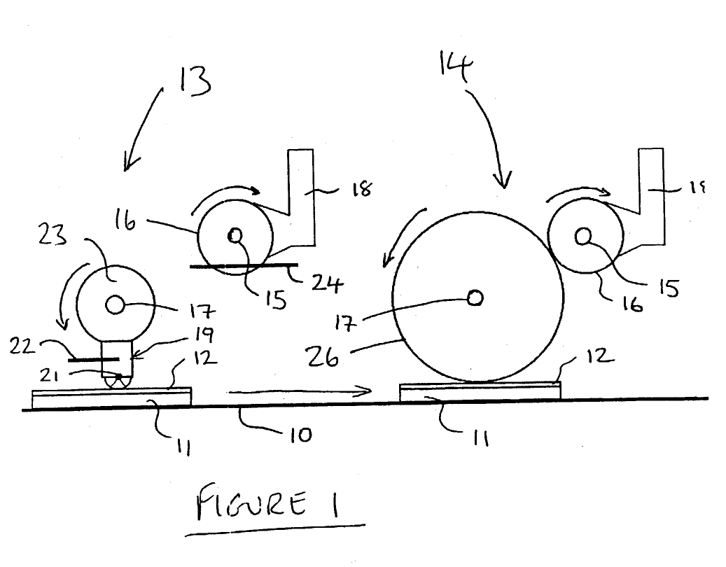

FIG. 2 is an end view of the apparatus of FIG. 1.

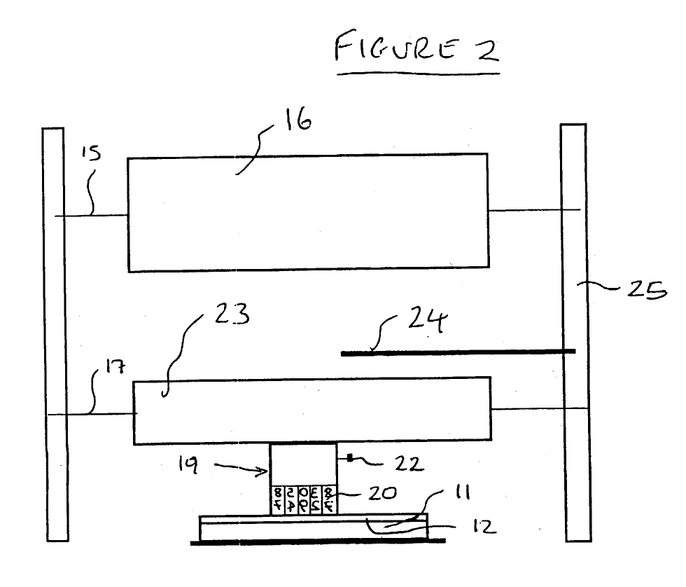

### DETAILED DESCRIPTION OF THE PREFERRED EMBODIMENTS

Referring to the drawings, there is shown a printing apparatus in accordance with this invention for printing successive serial numbers onto compact or optical memory disks.

The apparatus comprises a conveyor 10 which is arranged to convey a plurality of successive support members 11 through a plurality of printing stations e.g. 13,14. Each support member 11 comprises means for mounting a compact disk (CD) 12 with its surface to be printed facing upwardly, such that the successive disks are transported through their own plane through the printing stations 13,14.

Each printing station 13,14 comprises two rotational shafts 15,17 mounted parallel to the plane of the disks 12 and extending transverse to the direction of movement of the conveyor 10. A first one of the shafts 15 is mounted further away from the conveyor 10 than the other shaft 17 and is displaced rearwardly with respect to the direction of travel of the conveyor 10.

Each of the shafts 15 carries a drum 16 having an outer surface formed with a plurality of grooves. An ink reservoir 18 has an outlet sealed against the exterior of the drum 16 and in use, ink is applied to the surface of the drum 16 as it is rotated in the direction shown. The depth and position of the grooves on the drum govern the amount of ink which it carries.

In accordance with this invention, the lower shaft 17 of one of the printing stations 13 carries an incremental counting device 19 comprising a plurality of wheels 20 mounted side-by-side on a shaft 21 which extends parallel to the shafts 15,17. Each wheel 20 carries raised reverse images of the digits 0-9 arranged in respective circumferential zones. The number presented by the wheels is arranged to increment by one each time a lever 22 on the device 19 is actuated.

The device 19 is mounted on a carrier 23 fixed to the shaft 17. In use, when the shaft 17 rotates in the direction shown, the lever 22 contacts an arm 24 securely mounted to the chassis 25 of the apparatus, such that the number presented by the wheels 20 is incremented by one. The wheels 20 then come into contact with the inked drum 16 which transfers ink onto the presented row of numbers.

Continued rotation of the shaft 17 causes the device 19 to come into contact with the surface of a CD 12 located directly below the shaft 17, such that the ink on the presented row of numbers is transferred onto the surface of the disk.

The shaft 17 then continues to rotate and the printed CD is moved on to the next printing station 14 and a new CD is advanced to the station 13. It will be appreciated that the new CD 12 is printed with a different number, since the device 19 increments by one on every revolution. However, this can be varied, so that the number increments, say every two or more CDs.

The shaft 17 of the second printing station 14 carries a drum 26 which is provided on its external surface with a reverse of a fixed image to be printed on to the CD in register with the printed serial number. Further printing stations may be provided upstream and/or downstream of the station 13 which prints the serial numbers.

All of the stations are synchronised with each other and thus it will be appreciated that complex images can be built up using different colours and embodying the serial number.

While the preferred embodiment of the invention have been shown and described, it will be apparent to those skilled in the art that changes and modifications may be made therein without departing from the spirit of the invention, the scope of which is defined by the appended claims.

We claim:

1. A method of printing incremental data onto successive 3-dimensional substrates comprising: applying a printing substance to a print head carrying reverse impressions of a series of characters;
applying the print head to the surface of a substrate to be printed to print a character;
removing said print head from the substrate; and,
changing character prior to contacting said print head with the surface of a subsequent substrate to be printed.

2. A method as claimed in claim 1, in which the printing substance is applied to a transfer element, said print head being contacted with the transfer element to apply the printing substance thereto.

3. A method as claimed in claim 1, in which the substrate further printed with an image prior to applying said print head to the substrates.

4. A method as claimed in claim 1, in which said substrate is further printed with an image subsequent to applying said print head to the substrate.

5. A method as claimed in claim 1, in which said substrate is further printed with an image simultaneously with applying said print head to the substrate.

6. An apparatus for printing incremental data onto successive 3-dimensional substrates comprising a print head carrying reverse impressions of a series of characters, means for applying a printing substance to the print head, means for applying said print head onto the surface of a substrate to be printed to print a character thereon, and means for changing at least one of the characters prior to printing onto a subsequent substrate.

7. An apparatus as claimed in claim 6, in which said print head is rotatably mounted for rotation between a first position in which it contacts said means for applying the printing substance and a second position in which it contacts said substrate.

8. An apparatus as claimed in claim 7, in which said means for changing the character changes said at least one character during rotational movement of said print head.

9. An apparatus as claimed in claim 8, in which said print head comprises an actuator which contacts a projection on the apparatus during rotational movement of said print head to change the character.

10. An apparatus as claimed in claim 7, in which said means for applying the printing substance comprises a roller arranged for rotation about an axis which extends parallel to the axis of rotation of said print head, means being provided for applying said substance to the roller.

11. An apparatus as claimed in claim 10, in which said print head and roller rotate in opposite directions.

12. An apparatus as claimed in claim 6, in which said substrate is mounted on a conveyor arranged to advance the substrate through successive printing stations, one of which includes said print head.
